(19) United States
(12) Patent Application Publication
(10) Pub. No.: US 2015/0123408 A1
(43) Pub. Date: May 7, 2015

(54) PUSHBUTTON LATCH MECHANISM FOR A VEHICLE

(71) Applicant: GM GLOBAL TECHNOLOGY OPERATIONS LLC, Detroit, MI (US)

(72) Inventor: Michael J. Longo, Sterling Heights, MI (US)

(73) Assignee: GM GLOBAL TECHNOLOGY OPERATIONS LLC, Detroit, MI (US)

(21) Appl. No.: 14/073,343

(22) Filed: Nov. 6, 2013

(51) Int. Cl. E05C 1/14; E05B 83/30

(52) U.S. Cl. CPC E05C 1/14; E05B 83/30
USPC 292/137

(57) ABSTRACT

A pushbutton latch mechanism includes a module housing having first, second and third housing walls defining respective housing openings. The mechanism may be employed in a glove box assembly in a vehicle. An actuator is positioned at least partially within the module housing and defines an actuator slot. The actuator includes an actuator arm configured to be slidable relative to the second housing opening. A pushbutton is operatively connected to the module housing and includes a button arm configured to be insertable into the actuator slot and the first housing opening. Depression of the pushbutton in a first direction causes a first angled surface of the button arm to engage with a second angled surface of the actuator arm, thereby translating the actuator arm and a latch arm in a second direction in order to move the latch mechanism to an unlatched position.

### TECHNICAL FIELD

The invention relates generally to a latch mechanism, and more particularly, to a pushbutton latch mechanism that may be used in a glove box assembly in a vehicle.

### BACKGROUND OF THE INVENTION

A vehicle generally includes a glove box assembly having a latch mechanism to latch and unlatch a door of the glove box assembly. The latch mechanism typically employs numerous mechanical parts, such as screws, levers and two latch arms that are engaged to open the door.

### SUMMARY OF THE INVENTION

A latch mechanism with latched and unlatched positions includes a module housing having first, second and third housing walls. The housing walls define respective first, second and third housing openings. An actuator is positioned at least partially within the module housing and defines an actuator slot. The actuator includes an actuator arm configured to be slidable relative to the second housing opening. A pushbutton is operatively connected to the module housing and includes a button arm configured to be insertable into the actuator slot and the first housing opening. Depression of the pushbutton in a first direction causes a first angled surface of the button arm to engage with a second angled surface of the actuator arm, thereby translating the actuator arm and a latch arm in a second direction in order to move the latch mechanism to the unlatched position.

The latch mechanism employs a single latch arm instead of two latch arms that are typically used and reduces the number of total parts typically required for a glove box assembly. Additionally, the latch mechanism allows for reduced travel distance for the pushbutton, bringing the components closer to the door surface and allowing for greater storage room.

The first direction may be substantially perpendicular relative to the second direction. The button arm may be configured to be extendable through the third housing opening. A housing cover is operatively connected to the module housing. A first biasing member is operatively connected to the housing cover and the actuator.

A flange portion extends from the first housing opening. The flange portion includes first and second flange walls and a finger portion positioned between the first and second flange walls. A button slot is defined in the button arm. The finger portion includes a protrusion configured to grip onto the button slot when the pushbutton is released to a resting position, thereby restraining the pushbutton from falling off relative to the module housing. The finger portion is at least partially composed of a first material and the first and second flange walls are at least partially composed from a second material. The first material is configured to be relatively flexible with respect to the second material.

First and second gaps may be defined between the finger portion and the first and second flange walls, respectively. The finger portion is configured to flex when the button arm is slid into the first housing opening. Third and fourth flange walls are defined by the flange portion and are contiguous with the first and second flange walls, respectively. The first and second flange walls may be substantially parallel. The third and fourth flange walls may be substantially parallel. The first flange wall may be substantially perpendicular relative to the third flange wall.

The actuator includes a base portion and a raised portion extending from the base portion. The base portion defines first, second and third actuator faces. The first actuator face is configured to be substantially perpendicular relative to each of the second and third actuator faces. The actuator slot extends at least partially along the first actuator face. The raised portion defines fourth, fifth, sixth, seventh and eighth actuator faces. The seventh actuator face is configured to be substantially perpendicular relative to each of the fourth, fifth, sixth and eighth actuator faces. The actuator slot extends at least partially along each of the first, fourth and seventh actuator faces. The actuator arm extends from the eighth actuator face.

A glove box assembly includes a frame mountable to a vehicle support member, such as an instrument panel or dashboard, a door operatively connected to the frame and the latch mechanism above having latched and unlatched positions for latching the door. The door includes door inner and outer panels. A second biasing member is operatively connected to the latch arm and the door inner panel and configured to bias the latch arm to the latched position of the mechanism. The door inner and outer panels define respective aligned cut-out edges which are sized to correspond to an edge of a button face of the pushbutton face.

The frame defines first and second frame openings. The door inner panel defines first and second door inner panel openings. The first frame opening is configured to be substantially aligned with both the second housing opening and the first door inner panel opening. The second frame opening is configured to be substantially aligned with the second door inner panel opening. The second end of the latch arm is configured to abut the second frame opening when the mechanism is in the latched position. The actuator arm is configured to abut the first door inner panel opening when the mechanism is in the latched position. A ramped surface is defined by the door inner panel and configured to substantially align the actuator arm to the first door inner panel opening.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic fragmentary perspective view of a glove box assembly having a latch mechanism and door;

FIG. 2 is a schematic fragmentary perspective view of the latch mechanism of FIG. 1, the latch mechanism including an actuator and a pushbutton;

FIG. 3 is a schematic fragmentary sectional view of the glove box assembly through axis 3-3 of FIG. 1, with the latch mechanism in a latched position;

FIG. 4 is a schematic fragmentary sectional view of the glove box assembly through axis 3-3 of FIG. 1, with the latch mechanism in an unlatched position;

FIG. 5 is a schematic perspective view of the actuator of FIGS. 2; and

FIG. 6 is a schematic fragmentary perspective view of portions of the door inner panel and the actuator of FIGS. 2-5.

### DESCRIPTION OF THE PREFERRED EMBODIMENTS

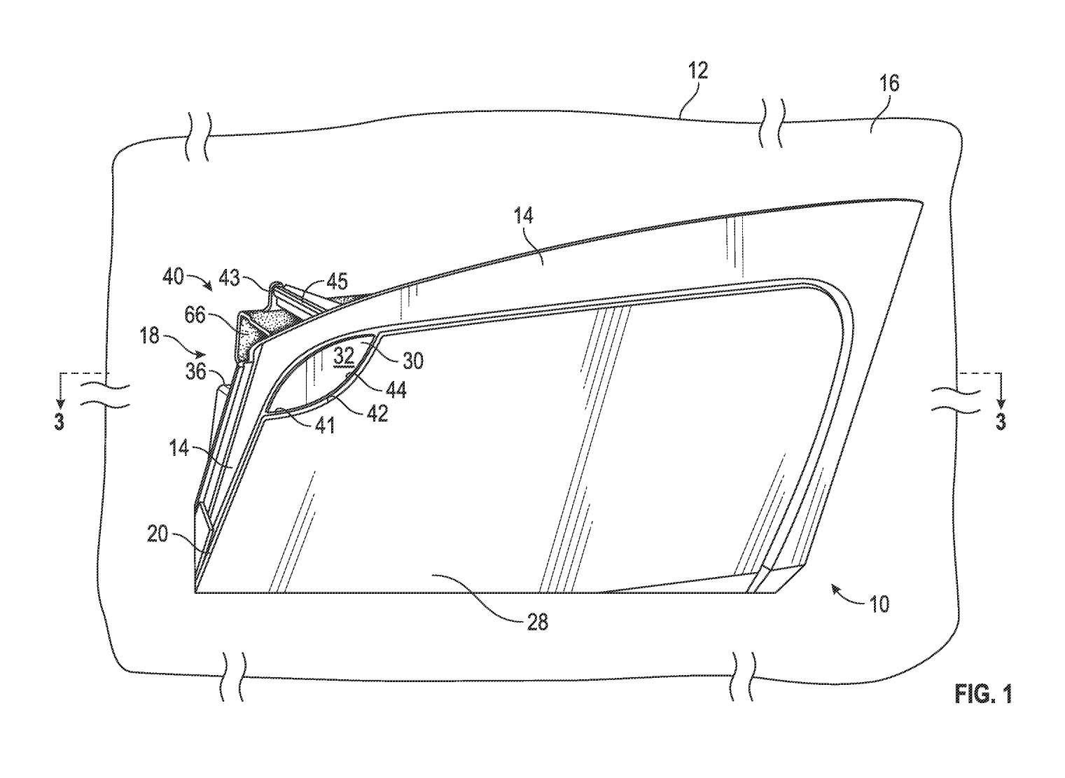

Referring to the drawings, wherein like reference numbers refer to like components, FIG. 1 shows a glove box assembly 10 that may be employed in a vehicle 12. The assembly 10 includes a frame 14 mountable to a vehicle support member 16, such as an instrument panel or dashboard, and a latch mechanism 18.

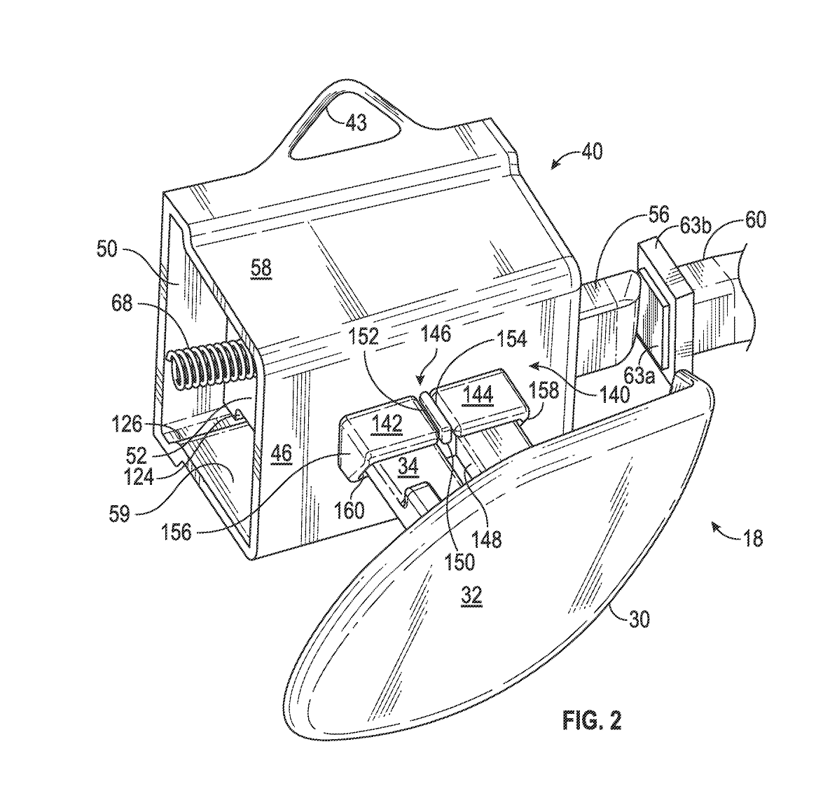

FIG. 2 is a schematic fragmentary perspective view of the latch mechanism 18. Referring to FIG. 2, the latch mechanism 18 includes a pushbutton 30. The pushbutton 30 includes a button face 32 and a button arm 34. Referring to FIG. 1, the latch mechanism 18 is capable of being fastened, such that a door 20 maintains closure of a storage compartment 36. The door 20 is operatively connected to the frame 14. Referring to FIG. 1, the latch mechanism 18 is capable of being released by the pushbutton 30 (shown in FIG. 2) to permit the door 20 to open access to the storage area 36. The latch mechanism 18 may be employed for providing access to any type of storage areas in the vehicle 12.

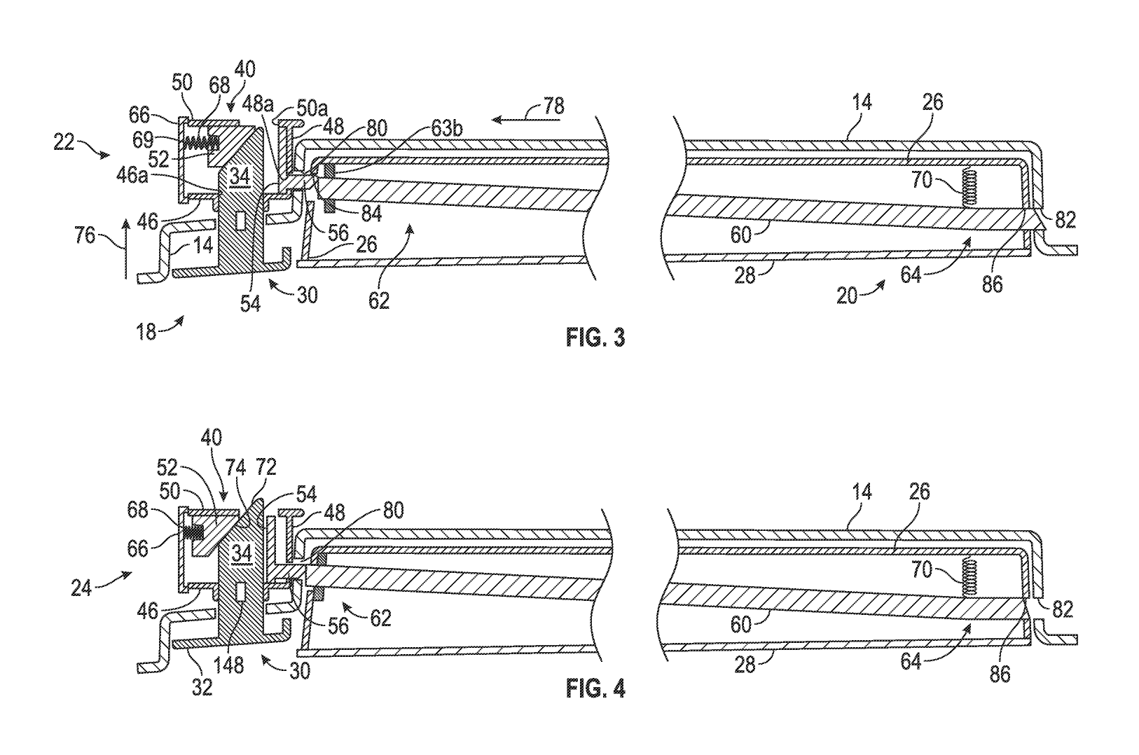

FIG. 3 is a schematic fragmentary sectional view of the glove box assembly 10 through axis 3-3 of FIG. 1, with the latch mechanism 18 and door 20 in a latched position 22. FIG. 4 is a schematic fragmentary sectional view of the glove box assembly 10 through axis 3-3 of FIG. 1, with the latch mechanism 18 and door 20 in an unlatched position 24 (just before the door 20 falls open). The door 20 includes a door inner panel 26 (shown in FIGS. 3-4) and a door outer panel 28 (shown in FIGS. 1, 3-4).

Referring to FIG. 1, the door inner and outer panels 26, 28 define respective aligned cut-out edges 41, 42. The cut-out edges 41, 42 are aligned relative to one another and sized to correspond to an edge 44 of the button face 32. The glove box assembly 10 may include other support structures (not shown) and various wiring, reinforcement members and other hardware, as known by those skilled in the art.

Referring to FIGS. 1-4, the latch mechanism 18 includes a module housing 40 that is operatively connected to the frame 14. The module housing 40 is lightly shaded in FIG. 1 for clarity. Referring to FIG. 1, module housing 40 may include a locator hole 43 configured for attachment to fastener 45. Fastener 45 may be inserted through locator hole 43 to align and couple the module housing 40 to the frame 14. Fastener 45 may be integrally formed with or otherwise operatively connected to the frame 14. Referring to FIGS. 3-4, the module housing 40 includes first, second and third housing walls 46, 48, 50. Referring to FIG. 3, the first, second and third housing walls 46, 48, 50 define respective first, second and third housing openings 46a, 48a, 50a.

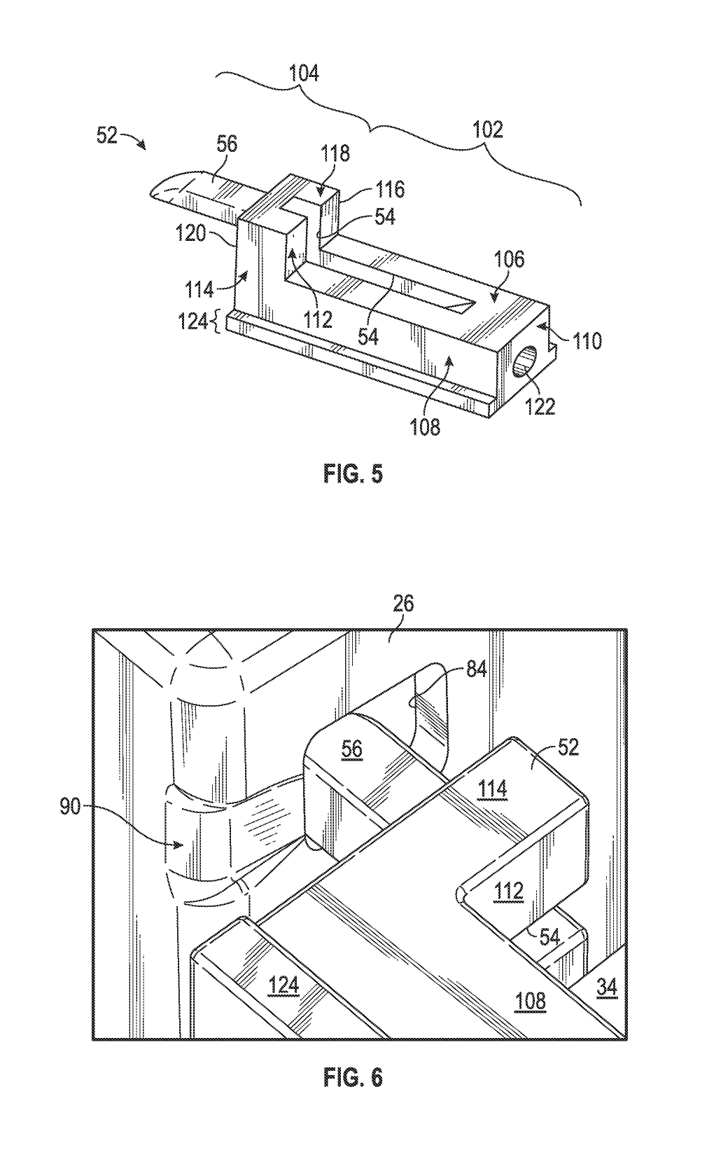

Referring to FIGS. 3-4, an actuator 52 is positioned at least partially within the module housing 40 and defines an actuator slot 54. FIG. 5 is a schematic perspective view of the actuator 52. Referring to FIG. 3, the actuator 52 includes an actuator arm 56 configured to be slidable relative to the second housing opening 48A. The module housing 40 may be physically insertable into an aperture in the frame 14 as a unit containing the actuator 52

Referring to FIG. 2, the module housing 40 includes fourth and fifth housing walls 58, 59 (the first and third housing walls 46, 50 are also shown in FIG. 2). Referring to FIG. 3, the button arm 34 is configured to be slidable relative to or insertable into the actuator slot 54 and the first housing opening 46A. The actuator slot 54 is configured to at least partially overlap with the first housing opening 46A to allow the button arm 34 to be insertable into the actuator slot 54 and the first housing opening 46A. The button arm 34 may be configured to be extendable through the third housing opening 50A.

Referring to FIGS. 2-4, a latch arm 60 is operatively engaged with the actuator 52 at the actuator arm 56. Referring to FIGS. 3-4, the latch arm 60 may be operatively connected to the door inner panel 26 and defines a first end 62 and a second end 64. Referring to FIG. 2, the latch arm 60 includes first and second end portions 63A, 63B at the first end 62. The first end portion 63A has approximately the same dimensions or cross-sectional area as the latch arm 60. The second end portion 63B is between the latch arm 60 and first end portion 63A and is configured to have a greater cross-sectional area than both the latch arm 60 and first end portion 63A.

Referring to FIGS. 1, 3 and 4, a lid or housing cover 66 is rigidly attached to the first and third housing walls 46, 50. The housing cover 66 is also rigidly attached to the fourth and fifth housing walls 58, 59. Referring to FIGS. 3-4, a first biasing member 68 is operatively connected to the housing cover 66. Note that the housing cover 66 is removed for clarity in FIG. 2, to show the first biasing member 68 and actuator 52 inside the module housing 40. Referring to FIG. 3, the first biasing member 68 may be attached to an indentation 69 in the actuator 52. In the embodiment shown, the first biasing member 68 is a compression spring that is compressed when the pushbutton 30 is depressed. Any type of biasing member may be employed for the first biasing member 68.

Referring to FIGS. 3-4, a second biasing member 70 is operatively connected to the latch arm 60 and the door inner panel 26. The second biasing member 70 is configured to bias the latch arm 60 to the latched position 22 (shown in FIG. 3) of the latch mechanism 18. The first biasing member 68 is configured to be substantially stronger than the second biasing member 70. In one non-limiting example, the first biasing member 68 may have a spring constant that is approximately five times the spring constant of the second biasing member 70. The first end 62 of the latch arm 60 is operatively engaged with the actuator arm 56 due to the spring tensions of the first and second biasing members 68, 70.

Referring to FIGS. 3-4, the button arm 34 defines a first angled surface 72 and the actuator 52 defines a second angled surface 74 engageable with the first angled surface 72. Referring to FIG. 3, depression of the button face 32 in a first direction 76 causes the first and second angled surfaces 72, 74 to engage, thereby translating the actuator arm 56 and the latch arm 60 in a second direction 78 in order to move the latch mechanism 18 to the unlatched position 24 and allow the door 20 to open (described in greater detail below). Referring to FIG. 3, the first direction 76 may be substantially perpendicular relative to the second direction 78.

Referring to FIGS. 3-4, the frame 14 defines substantially-opposed first and second frame openings 80, 82. The door inner panel 26 defines substantially-opposed first and second door inner panel openings 84, 86. Referring to FIG. 3, the first frame opening 80 is configured to be substantially aligned with the second housing opening 48A and the first door inner panel opening 84. The second frame opening 82 is configured to be substantially aligned with the second door inner panel opening 86.

FIG. 6 is a schematic fragmentary perspective view showing a portion of the door inner panel 26 and the actuator arm 56. Referring to FIG. 6, a ramped surface 90 is defined by the door inner panel 26 and extends or slopes into the first door inner panel opening 84. The ramped surface 90 is configured to substantially align the actuator arm 56 to the first door inner panel opening 84 (also shown in FIGS. 3-4). The ramped surface 90 is configured to prevent misalignment of the actuator arm 56 relative to the first door inner panel opening 84.

Referring now to FIG. 5, the actuator 52 includes a base portion 102 and a raised portion 104 extending from the base portion 102. The base portion 102 defines first, second and third actuator faces 106, 108, 110. Referring to FIG. 5, the first actuator face 106 is configured to be substantially perpendicular relative to each of the second and third actuator faces 108, 110. The actuator slot 54 extends at least partially along the first actuator face 106.

Referring still to FIG. 5, the raised portion 104 defines fourth, fifth, sixth, seventh and eighth actuator faces 112, 114, 116, 118 and 120. The actuator slot extends at least partially along each of the first, fourth and seventh actuator faces 106, 112, 118. The actuator arm 56 extends from the eighth actuator face 120. The fourth actuator face 112 is configured to be substantially parallel to the eighth actuator face 120. The fifth actuator face 114 is configured to be substantially parallel to the sixth actuator face 116. The seventh actuator face 118 is configured to be substantially perpendicular relative to each of the fourth, fifth, sixth and eighth actuator faces 112, 114, 116 and 120. The fourth and eighth actuator faces 112, 120 are configured to be substantially perpendicular to the fifth and sixth actuator faces 114, 116.

Referring to FIG. 5, the third actuator face 110 defines a hole 122. The first biasing member 68 (shown in FIGS. 2-4) is configured to extend at least partially through the hole 122. Referring to FIG. 5, the actuator 52 includes a step portion 124 extending substantially along the second actuator face 108 and fifth actuator face 114. Referring to FIG. 2, the fifth wall 59 of the module housing 40 includes a corresponding valley portion 126. The valley portion 126 is configured to locate the step portion 124 of the actuator 52 and provide stability to the module housing 40.

Referring now to the operation of the latch mechanism 18, as noted above and referring to FIG. 3, depression of the button face 32 in a first direction 76 causes the first and second angled surfaces 72, 74 to engage, thereby translating the actuator arm 56 and the latch arm 60 in a second direction 78 in order to move the latch mechanism 18 to the unlatched position 24 and allow the door 20 to open. Referring to FIG. 4, depression of the pushbutton 30 (at the button face 32) in the first direction 76 (see FIG. 3) causes the first angled surface 72 of the button arm 34 to engage with the second angled surface 74 of the actuator arm 56, compressing the first biasing member 68. This causes the actuator arm 56 and the latch arm 60 to translate/retract in the second direction 78 (shown in FIG. 3), moving the latch mechanism 20 to the unlatched position 24 which allows the door 20 to open.

The first biasing member 68 acts as the releasing mechanism when the pushbutton 30 is released. Referring to FIG. 3, when the pushbutton 30 is no longer depressed, the first biasing member 68 pushes the second angled surface 72 of the actuator arm 56. The second angled surface 74 of the actuator arm 56 in turn pushes on the first angled surface 72 of the button arm 34, pushing the pushbutton 30 back into the resting position of FIG. 3. The pushbutton 30 is stopped in the resting position by the finger portion 146, as described below.

As shown in FIG. 3, when the latch mechanism 18 is in the latched position 22, the actuator arm 56 is configured to abut or extend through the first door inner panel opening 84 while the second end 64 of the latch arm 60 is configured to abut or extend through the second frame opening 82. This prevents the door 20 from opening in the latched position 22. As shown in FIG. 4, in the unlatched position 24, the actuator arm 56 no longer extends through or abuts the first door inner panel opening 84 and the second end 64 of the latch arm 60 no longer extends through or abuts the second frame opening 82.

Referring now to FIG. 2, a flange portion 140 extends from the first wall 46 of the module housing 40. The flange portion 140 extends around the first housing opening 46A. The flange portion 140 includes first and second flange walls 142, 144 and a finger portion 146 positioned between the first and second flange walls 142, 144.

Referring to FIGS. 2 and 4, a button slot 148 is defined in the button arm 34. The finger portion 146 includes a protrusion 150 configured to grip onto the button slot 148 when the pushbutton 30 is released to a resting position (shown in FIG. 3), thereby restraining the pushbutton 30 from falling off relative to the module housing 40. In other words, the finger portion 146 is configured to snap into the button slot 148 to restrain the pushbutton 30 after an operator releases pressure from the button face 32. Thus, no additional spring is needed to constrain the motion of the pushbutton 30 after the operator releases the pushbutton 30.

Referring to FIG. 2, first and second gaps 152, 154 may be defined between the finger portion 146 and the first and second flange walls 142, 144, respectively. The first and second gaps 152, 154 allow the finger portion 146 to flex when the button arm 34 is slid into the first housing opening 46A, i.e., when loading the pushbutton 30. Stated differently, the finger portion 146 is disassociated from the first and second flange walls 142, 144 so that the finger portion 146 can bend and allow for the button arm 34 to slide into the first housing opening 46A. By keeping the finger portion 146 disassociated from the first and second flange walls 142, 144, if the pushbutton 30 breaks, only the pushbutton 30 needs to be replaced instead of the entire latch mechanism 18.

The finger portion 146 may be at least partially composed of a first material while the first and second flange walls 142, 144 may be at least partially composed from a second material, the first material relatively flexible with respect to the second material. The first and second flange walls 142, 144 may be composed of a substantially rigid material such as a metal or rigid plastic. The finger portion 146 may be composed of a substantially flexible material such as an elastomer, polymer, flexible plastic or combinations thereof. Examples of elastomers that may be used to form the finger portion include, but are not limited to: polyurethane, cis-1,4-polyisoprene natural rubber (NR), synthetic polyisoprene, polybutadiene, neoprene, silicone, polychloroprene, baypren, butyl rubber (copolymer of isobutylene and isoprene), halogenated butyl rubbers, styrene-butadiene rubber (copolymer of styrene and butadiene), nitrile rubber (copolymer of butadiene and acrylonitrile), ethylene propylene rubber, ethylene propylene diene rubber, a terpolymer of ethylene, propylene and a diene-component) chlorosulfonated polyethylene and ethylene-vinyl acetate.

Referring to FIG. 2, third and fourth flange walls 156, 158 may be defined by the flange portion 140. The third and fourth flange walls 156, 158 may be contiguous with the first and second flange walls 142, 144, respectively. The first and second flange walls 142, 144 may be substantially parallel. The third and fourth flange walls 156, 158 may be substantially parallel. The first and second flange walls 142, 144 may be substantially perpendicular relative to the third and fourth flange walls 156, 158.

Referring to FIG. 2, a clearance 160 is defined between the button 30 and the module housing 40. The clearance 160 is configured to prevent squeaking In one example, the clearance 160 is approximately between 0.1 mm and 0.5 mm.

While the best modes for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

1. A latch mechanism having latched and unlatched positions, the mechanism comprising:
a module housing having first, second and third housing walls;
wherein the first, second and third housing walls define respective first, second and third housing openings;
an actuator positioned at least partially within the module housing and defining an actuator slot;
wherein the actuator includes an actuator arm configured to be slidable relative to the second housing opening;
a pushbutton operatively connected to the module housing and having a button arm configured to be insertable into the actuator slot and the first housing opening;
wherein the button arm defines a first angled surface and the actuator defines a second angled surface engageable with the first angled surface;
a latch arm operatively engaged with the actuator;
wherein depression of the pushbutton in a first direction causes the first and second angled surfaces to engage, thereby translating the actuator arm and the latch arm in a second direction in order to move the latch mechanism to the unlatched position.

2. The mechanism of claim 1, wherein:
the first direction is substantially perpendicular relative to the second direction; and
the button arm is configured to be extendable through the third housing opening.

3. The mechanism of claim 1, further comprising:
a housing cover operatively connected to the module housing; and
a first biasing member operatively connected to the housing cover and the actuator.

4. The mechanism of claim 1, further comprising:
a flange portion extending from the first housing opening, the flange portion including first and second flange walls and a finger portion positioned between the first and second flange walls;
a button slot defined in the button arm; and
wherein the finger portion includes a protrusion configured to grip onto the button slot when the pushbutton is released.

5. The mechanism of claim 4, further comprising:
first and second gaps defined between the finger portion and the first and second flange walls, respectively; and
wherein the finger portion is configured to flex when the button arm is slid into the first housing opening.

6. The mechanism of claim 4, wherein:
the finger portion is at least partially composed of a first material and the first and second flange walls are at least partially composed from a second material, the first material being relatively flexible with respect to the second material.

7. The mechanism of claim 4, further comprising:
third and fourth flange walls defined by the flange portion and contiguous with the first and second flange walls, respectively;
wherein the first and second flange walls are substantially parallel;
wherein the third and fourth flange walls are substantially parallel; and
wherein the first flange wall is substantially perpendicular relative to the third flange wall.

8. The mechanism of claim 1, wherein:
the actuator includes a base portion and a raised portion extending from the base portion;
the base portion defines first, second and third actuator faces;
the first actuator face is configured to be substantially perpendicular relative to each of the second and third actuator faces;
the actuator slot extends at least partially along the first actuator face.

9. The mechanism of claim 8, wherein.
the raised portion defines fourth, fifth, sixth, seventh and eighth actuator faces, the actuator slot extending at least partially along each of the first, fourth and seventh actuator faces;
the actuator arm extends from the eighth actuator face; and
the seventh actuator face is configured to be substantially perpendicular relative to each of the fourth, fifth, sixth and eighth actuator faces.

10. A glove box assembly comprising:
a frame;
a door operatively connected to the frame and including a door inner panel and a door outer panel;
a latch mechanism operatively connected to the frame and having latched and unlatched positions for unlatching the door, the mechanism including:
a module housing having first, second and third housing walls defining respective first, second and third housing openings;
an actuator positioned at least partially within the module housing and defining an actuator slot;
a pushbutton operatively connected to the module housing and having a button arm configured to be insertable into the actuator slot and the first housing opening; and
a latch arm operatively operatively engaged with the actuator;
wherein the actuator includes an actuator arm configured to be slidable relative to the second housing opening;
wherein the button arm defines a first angled surface and the actuator defines a second angled surface engageable with the first angled surface; and
wherein depression of the pushbutton in a first direction causes the first and second angled surfaces to engage, thereby translating the actuator arm and the latch arm in a second direction in order to selectively unlatch the door.

11. The assembly of claim 10, further comprising:
a flange portion extending from the first housing opening, the flange portion including first and second flange walls and a finger portion positioned between the first and second flange walls;
a button slot defined in the button arm; and
wherein the finger portion includes a protrusion configured to grip onto the button slot when the pushbutton is released.

12. The assembly of claim 11, further comprising:
first and second gaps defined between the finger portion and the first and second flange walls, respectively; and
wherein the finger portion is configured to flex when the button arm is slid into the first housing opening.

13. The assembly of claim 10, wherein:
the actuator includes a base portion and a raised portion extending from the base portion;
the base portion defines first, second and third actuator faces;
the first actuator face is configured to be substantially perpendicular relative to each of the second and third actuator faces;
the actuator slot extends at least partially along the first actuator face.

14. The assembly of claim 10, wherein the latch mechanism includes:
a second biasing member operatively connected to the latch arm and the door inner panel, the second biasing member being configured to bias the latch arm to the latched position.

15. The assembly of claim 10, wherein the pushbutton includes a button face and further comprising:
respective aligned cut-out edges defined by the door inner and outer panels, the respective aligned cut-out edges being sized to correspond to an edge of the button face.

16. The assembly of claim 10, wherein:
the frame defines first and second frame openings;
the door inner panel defines first and second door inner panel openings;
wherein the first frame opening is configured to be substantially aligned with the second housing opening and the first door inner panel opening; and
wherein the second frame opening is configured to be substantially aligned with the second door inner panel opening.

17. The assembly of claim 16, wherein:
the second end of the latch arm is configured to abut the second frame opening when the mechanism is in the latched position; and
the actuator arm is configured to abut the first door inner panel opening when the mechanism is in the latched position.

18. The assembly of claim 16, further comprising:
a ramped surface defined by the door inner panel and configured to align the actuator arm to the first door inner panel opening.

19. A vehicle comprising:
a support member;
a glove box assembly mountable to the support member, the glovebox assembly having:
a frame mounted to the support member;
a door operatively connected to the frame;
a latch mechanism operatively connected to the frame and having latched and unlatched positions for unlatching the door, the mechanism including:
a module housing having first, second and third housing walls defining respective first, second and third housing openings, the module housing being insertable into the frame;
an actuator positioned at least partially within the module housing and defining an actuator slot;
a pushbutton operatively connected to the module housing and having a button arm configured to be insertable into the actuator slot and the first housing opening; and
a latch arm operatively engaged with the actuator;
wherein the actuator includes an actuator arm configured to be slidable relative to the second housing opening;
wherein the button arm defines a first angled surface and the actuator defines a second angled surface engageable with the first angled surface; and
wherein depression of the pushbutton in a first direction causes the first and second angled surfaces to engage, thereby translating the actuator arm and the latch arm in a second direction in order to selectively unlatch the door.
